(19) United States
(12) Patent Application Publication
(10) Pub. No.: US 2015/0156096 A1
(43) Pub. Date: Jun. 4, 2015

(54) VIRTUALIZATION SERVICE APPARATUS AND METHOD OF PROVIDING VIRTUALIZATION SERVICE

(71) Applicant: Electronics and Telecommunications Research Institute, Daejeon (KR)

(72) Inventor: Hyun-Suk ROH, Daejeon (KR)

(21) Appl. No.: 14/309,149

(22) Filed: Jun. 19, 2014

(30) Foreign Application Priority Data
Nov. 29, 2013 (KR) 10-2013-0147715

(51) Int. Cl. H04L 12/26; G06F 9/455

(52) U.S. Cl. CPC H04L 43/0876; G06F 9/455

(57) ABSTRACT

Disclosed herein is a virtualization service apparatus including: a network monitoring unit receiving a virtualization service request for a content and network delay time information from a terminal; a content monitoring unit setting a delay limitation depending on a type of the content; a transmission rate controlling unit setting a transmission rate depending on an available bandwidth of a network; a content bit rate controlling unit setting a content bit rate depending on the transmission rate, the delay limitation, and the network delay time; an encoding configuration controlling unit setting a resolution and a frame rate depending on the content bit rate and the type of the content; a content quality controlling unit encoding the content depending on the resolution and the frame rate; and a transmitting unit transmitting the encoded content to the terminal.

### CROSS REFERENCE TO RELATED APPLICATION

This application claims the benefit of Korean Patent Application No. 10-2013-0147715, filed on 29 Nov. 2013, entitled “Virtualization Service Apparatus and Method of Providing Virtualization Service”, which is hereby incorporated by reference in its entirety into this application.

### BACKGROUND OF THE INVENTION

1. Technical Field

The present invention relates to a virtualization service technology, and more particularly, to a virtualization service technology adaptive to network and content characteristics.

2. Description of the Related Art

Recently, in accordance with an increase in an interest in a cloud based virtualization service, services such as View of VMware, XenDesktop of Citrix, and the like, have been commercialized as a virtualization desktop solution. In addition, services such as OnLive of Rearden, Gaikai of GaiKai Inc., and the like, have been spotlighted as a cloud game solution for providing a game requiring a high graphic processing capability to low specification mobile terminals.

Since the cloud based virtualization service transfers a request of a user through a network and a server performs an operation depending on the request and transfers an operation result to a user terminal, it is sensitive to a packet loss and a delay. The packet loss deteriorates image quality of a frame transferred from the server, and the delay has an influence on responsibility and continuity of the virtualization service.

Therefore, various methods have been suggested in order to improve quality of the cloud based virtualization service. However, existing methods have focused on a distance between a server and a terminal, an available bandwidth, caching, graphic processing, and the like, and do not reflect characteristics of a delay limitation required by contents depending on a change in the contents and quality (high resolution, high frame rate) required by the user depending on a kind of contents.

### SUMMARY OF THE INVENTION

An object of the present invention is to provide a virtualization service apparatus and a method of providing a virtualization service that are capable of determining a content bit rate and an encoding configuration adaptively to network and content characteristics.

According to an exemplary embodiment of the present invention, there is provided a virtualization service apparatus including: a network monitoring unit receiving a virtualization service request for a content and network delay time information from a terminal; a content monitoring unit setting a delay limitation depending on a type of the content; a transmission rate controlling unit setting a transmission rate depending on an available bandwidth of a network; a content bit rate controlling unit setting a content bit rate depending on the transmission rate, the delay limitation, and the network delay time; an encoding configuration controlling unit setting a resolution and a frame rate depending on the content bit rate and the type of the content; a content quality controlling unit encoding the content depending on the resolution and the frame rate; and a transmitting unit transmitting the encoded content to the terminal.

The encoding configuration controlling unit may set the resolution and the frame rate with reference to a profile including resolutions and frame rates preset depending on each content bit rate and each type of the contents.

The content bit rate controlling unit may set the content bit rate depending on the transmission rate, and the content bit rate controlling unit may decrease the content bit rate in the case in which the network delay time exceeds the delay limitation and increase the content bit rate in the case in which the network delay time is the delay limitation or less.

The network monitoring unit may receive receiving buffer state information from the terminal and calculate the available bandwidth, and the transmission rate controlling unit may set the transmission rate depending on the available bandwidth and the receiving buffer status information.

According to another exemplary embodiment of the present invention, there is provided a method of providing a virtualization service by a virtualization service apparatus, including: receiving a virtualization service request for a content and network delay time information from a terminal; setting a delay limitation depending on a type of the content; setting a transmission rate depending on an available bandwidth of a network; setting a content bit rate depending on the transmission rate, the delay limitation, and the network delay time; setting a resolution and a frame rate depending on the content bit rate and the type of the content; encoding the content depending on the resolution and the frame rate; and transmitting the encoded content to the terminal.

The setting of the resolution and the frame rate depending on the content bit rate and the type of the content may include setting the resolution and the frame rate with reference to a profile including resolutions and frame rates preset depending on each content bit rate and each type of the contents.

The setting of the content bit rate depending on the transmission rate, the delay limitation, and the network delay time may include: setting the content bit rate depending on the transmission rate; decreasing the content bit rate in the case in which the network delay time exceeds the delay limitation; and increasing the content bit rate in the case in which the network delay time is the delay limitation or less.

The method of providing a virtualization service may further include: receiving receiving buffer state information from the terminal; calculating the available bandwidth; and wherein setting a transmission rate depending on an available bandwidth of a network includes setting the transmission rate depending on the available bandwidth and the receiving buffer state information.

### BRIEF DESCRIPTION OF THE DRAWINGS

FIG. 1 is a diagram showing a virtualization service apparatus according to an exemplary embodiment of the present invention;

FIG. 2 is a flow chart showing a process of providing a virtualization service by the virtualization service apparatus according to an exemplary embodiment of the present invention; and

FIG. 3 is a flow chart showing a process of receiving a virtualization service by a terminal according to an exemplary embodiment of the present invention.

FIG. 4 illustrates how the virtualization service apparatus in accordance with an embodiment of the present invention is embodied in the form of a computer system.

### DESCRIPTION OF EXEMPLARY EMBODIMENTS

The present invention may be variously modified and have several exemplary embodiments. Therefore, specific exemplary embodiments of the present invention will be illustrated in the accompanying drawings and be described in detail in the present specification. However, it is to be understood that the present invention is not limited to a specific exemplary embodiment, but includes all modifications, equivalents, and substitutions without departing from the scope and spirit of the present invention.

Further, in the present specification, it is to be understood that when one component is referred to as “transmitting” a signal to another component, one component may be directly connected to another component to transmit a signal to another component or may transmit a signal to another component through any other components unless explicitly described to the contrary.

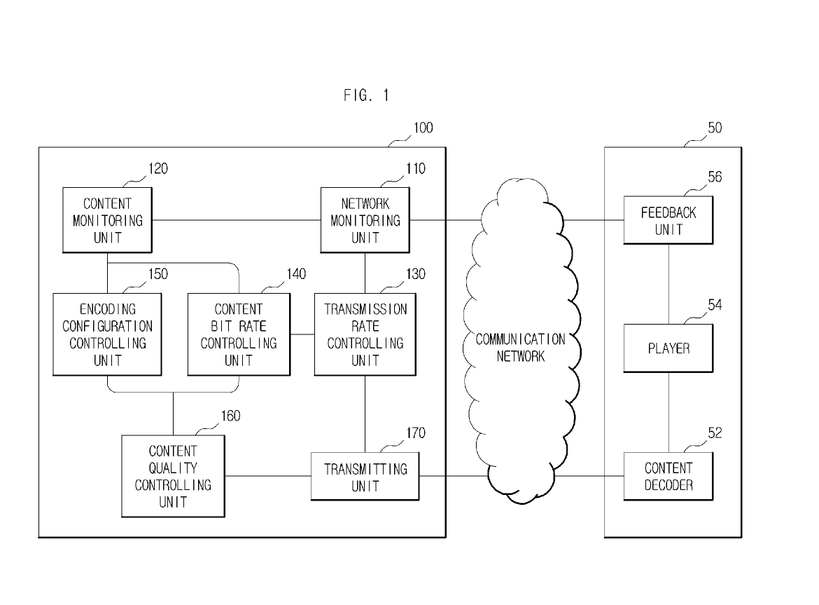

FIG. 1 is a diagram showing a virtualization service apparatus according to an exemplary embodiment of the present invention.

Referring to FIG. 1, the virtualization service apparatus 100 according to an exemplary embodiment of the present invention is configured to include a network monitoring unit 110, a content monitoring unit 120, a transmission rate controlling unit 130, a content bit rate controlling unit 140, an encoding configuration controlling unit 150, a content quality controlling unit 160, and a transmitting unit 170.

The network monitoring unit 110 receives receiving buffer state information indicating a virtualization service request requesting a virtualization service for a specific content from a terminal 50, a network delay time between the virtualization service apparatus 100 and the terminal 50, and a degree (a variable capacity, a stored data capacity, and the like) in which data are stored in a receiving buffer in the terminal 50 from the terminal 50. In addition, the network monitoring unit 110 may calculate an available bandwidth of the network by a well-known method such as a transmission control protocol (TCP)-friendly rate control (TFRC), Iperf, IGI/PTR, or the like, adjust the available bandwidth of the network depending on the receiving buffer state information, and transmit the adjusted available bandwidth to the transmission rate controlling unit 130. For example, in the case in which the available capacity depending on the receiving buffer state information is a predefined level or less, the network monitoring unit 110 may subtract a predefined numerical value from the calculated network available bandwidth. In addition, the network monitoring unit 110 transmits the virtualization service request to the content monitoring unit 120.

The content monitoring unit 120 searches a content corresponding to the virtualization service request and determines a type corresponding to the content. Here, the content monitoring unit 120 may determine types of the respective contents by confirming metadata included in the respective contents or content type information stored in a database in which the contents are stored. In addition, the content monitoring unit 120 transmits a delay limitation corresponding to the type of the corresponding content to the content bit rate controlling unit 140. Here, the content monitoring unit 120 may pre-store delay limitations corresponding to the types of the respective contents.

The transmission rate controlling unit 130 calculates a transmission rate depending on the available bandwidth of the network and the receiving buffer state information. In addition, the transmission rate controlling unit 130 transmits the transmission rate to the content bit rate controlling unit 140 and the transmitting unit 170.

The content bit rate controlling unit 140 calculates a content bit rate depending on the transmission rate, an end-to-end delay, and a delay limitation required by the content in order to ensure the delay limitation required by the content. The content bit rate controlling unit 140 transmits the content bit rate to the content quality controlling unit 160 and the encoding configuration controlling unit 150.

The encoding configuration controlling unit 150 pre-stores profiles including configuration information indicating frame rates and resolutions maximally satisfying quality of experience of a user for each content bit rate and each type of the contents, determines encoding configurations (resolution and frame rate) corresponding to the content bit rate and the type of the content with reference to the profile, and transmits the determined encoding configurations to the content quality controlling unit 160. Here, the profile may be information created so as to include the configuration information indicating the frame rates and the resolutions maximally satisfying the quality of experience of the user for each content bit rate and each type of the contents through a mean of score (MOS) experiment.

The content quality controlling unit 160 encodes the content so as to have content quality depending on the content bit rate and the encoding configuration using a well-known technology such as real-time transcoding, scalable video coding, real-time stream switching, and the like. The content quality controlling unit 160 transmits the encoded content to the transmitting unit 170.

The transmitting unit 170 transmits the encoded content to the terminal 50 depending on the transmission rate. Here, the transmitting unit 170 may include a transmitting buffer, and may receive the encoded content from the content quality controlling unit 160 and temporality store the encoded content. In addition, the transmitting unit 170 may stream the content stored in the transmitting buffer to the terminal 50.

Here, the terminal 50 may include a content decoder 52 decoding the content received from the virtualization service apparatus 100 depending on the content bit rate and a player 54 playing the decoded content. In addition, the terminal 50 may include a feedback unit creating the network delay time information and the receiving buffer state information and transmitting the network delay time information and the receiving buffer state information to the virtualization service apparatus 100.

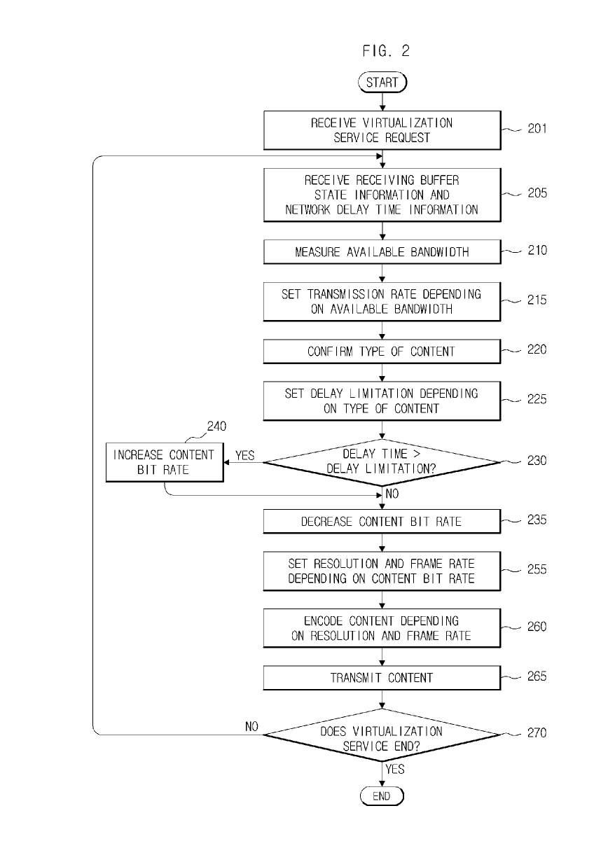

Next, a process of providing a virtualization service by the virtualization service apparatus according to an exemplary embodiment of the present invention will be described in detail with reference to FIG. 2.

FIG. 2 is a flow chart showing a process of providing a virtualization service by the virtualization service apparatus 100 according to an exemplary embodiment of the present invention. Although each step to be described below is performed by each function unit configuring the virtualization service apparatus 100, a subject performing each step will be commonly called the virtualization service apparatus 100 in order to simply and clearly describe the present invention.

Referring to FIG. 2, in step 201, the virtualization service apparatus 100 receives a virtualization service request for a specific content from the terminal 50.

In step 205, the virtualization service apparatus 100 receives receiving buffer state information and network delay time information from the terminal 50.

In step 210, the virtualization service apparatus 100 measures an available bandwidth of a network between the virtualization service apparatus 100 and the terminal 50.

In step 215, the virtualization service apparatus 100 sets a transmission rate depending on the available bandwidth of the network and the receiving buffer state information.

In step 220, the virtualization service apparatus 100 confirms a type of a content. For example, the virtualization service apparatus 100 confirms that the content is any one of the predefined types such as a document, a game, a moving picture, a picture, and the like.

In step 225, the virtualization service apparatus 100 sets a delay limitation of the content depending on the type of the content. For example, the virtualization service apparatus 100 sets the delay limitation of the corresponding content depending on delay limitations predefined so as to correspond to the types of the respective contents.

In step 230, the virtualization service apparatus 100 judges whether an end-to-end delay time exceeds an end-to-end delay limitation.

In the case in which it is judged in step 230 that the end-to-end delay time exceeds the end-to-end delay limitation, the virtualization service apparatus 100 decreases a content bit rate by a numerical value that is in proportion to a difference between the delay time and the delay limitation, in step 235. In this case, the virtualization service apparatus 100 may set an initial content bit rate depending on the transmission rate.

In the case in which it is judged in step 230 that the end-to-end delay time is the end-to-end delay limitation or less, the virtualization service apparatus 100 increases the content bit rate by the numerical value that is in proportion to the difference between the delay time and the delay limitation, in step 240.

In step 255, the virtualization service apparatus 100 sets a resolution and a frame rate at which the content is to be provided depending on the content bit rate. In this case, the virtualization service apparatus 100 may pre-store profiles in which resolutions and frame rates pre-defined for each content bit rate are defined and may set the resolution and the frame rate depending on the content bit rate according to the corresponding profile.

In step 260, the virtualization service apparatus 100 encodes the content depending on the resolution and the frame rate set in step 255.

In step 265, the virtualization service apparatus 100 transmits the encoded content to the terminal 50.

In step 270, the virtualization service apparatus 100 confirms whether the virtualization service will end. For example, the virtualization service apparatus 100 may confirm that the virtualization service has ended in the case in which it receives a signal requesting the end of the virtualization service from the terminal 50 or encoding and transmission of the corresponding content are completed.

In the case in which it is confirmed in step 270 that the virtualization service has not ended, the virtualization service apparatus 100 again performs processes from step 205.

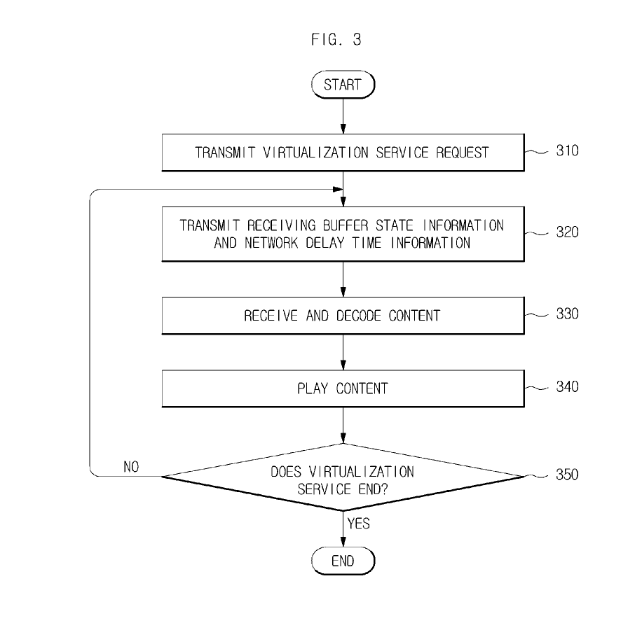

FIG. 3 is a flow chart showing a process of receiving a virtualization service by a terminal according to an exemplary embodiment of the present invention.

Referring to FIG. 3, in step 310, the terminal 50 transmits a virtualization service request for a specific content to the virtualization service apparatus 100.

In step 320, the terminal 50 measures a network delay time to create network delay time information and transmit the network delay time information to the virtualization service apparatus 100. And, the terminal 50 confirms data stored in the receiving buffer to create receiving buffer state information and transmit the receiving buffer state information to the virtualization service apparatus 100.

In step 330, the terminal 50 receives and decodes a content.

In step 340, the terminal 50 plays the decoded content.

In step 350, the terminal 50 confirms whether the virtualization service has ended. In this case, the terminal 50 may confirm that the virtualization service has ended by confirming whether or not streaming of the content depending on the virtualization service has ended or in the case in which it receives an input requesting the end of the virtualization service from the user.

In the case in which it is confirmed in step 350 that the virtualization service has not ended, the terminal 50 again performs processes from step 320.

Therefore, the virtualization service apparatus 100 according to an exemplary embodiment of the present invention may encode the content so as to have a frame rate and a resolution matched to characteristics of the content and may transmit the encoded content to the terminal 50. For example, in the case in which the content is a game or a moving picture, a high frame rate is required. Therefore, the virtualization service apparatus 100 may set a content bit rate as high as possible within a limit in a current network situation in consideration of a type of the content, and provide a content having a frame rate and a resolution corresponding to the high content bit rate to the terminal 50. Further, in the case in which the content is a still image such as a text or a photograph, the virtualization service apparatus 100 may set a lower content rate in consideration of a type of the content, and provide a content having a frame rate and a resolution corresponding to the low content bit rate to the terminal 50.

That is, since a cloud based virtualization service provides various kinds of contents (video, game, document, and the like), functions of transmitting a content that is being currently used by a user in a state in which characteristics of the content as well as characteristics of a network are reflected are required. Among them, a function of adaptively controlling a transmission rate and a bit rate of a content ensure the delay limitation is required. In addition, a function of adaptively determining an optimal frame rate and resolution when a content used by the user is changed and when a bit rate of the content is changed in consideration of an influence of the frame rate and the resolution on quality of experience of the user according to a kind of content is required. The virtualization service apparatus according to an exemplary embodiment of the present invention may provide the above-mentioned functions.

As set forth above, according to exemplary embodiments of the present invention, a virtualization service in which quality characteristics required for each content are reflected may be provided.

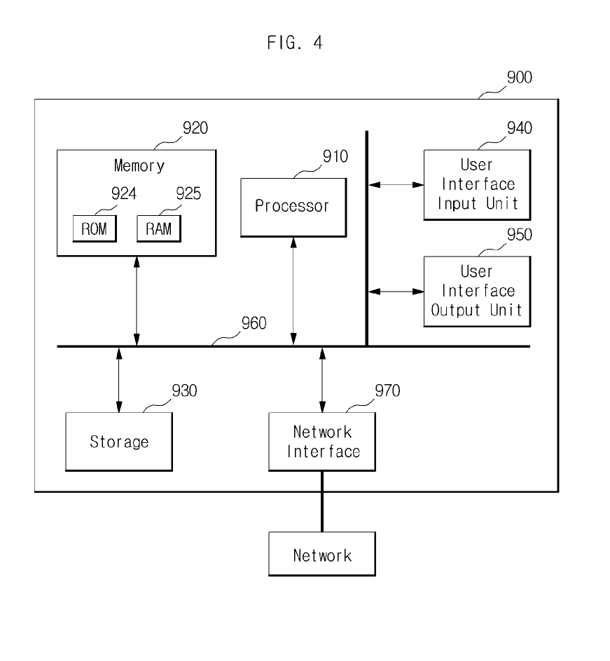

FIG. 4 illustrates how the virtualization service apparatus in accordance with an embodiment of the present invention is embodied in the form of a computer system.

The above-described the virtualization service apparatus may be implemented in a computer system, e.g., as a computer readable medium. As shown in in FIG. 4, a computer system 900 may include one or more of a processor 910, a memory 920, a user interface input unit 940, a user interface output unit 950, and a storage 930, each of which communicates through a bus 960. The computer system 900 may also include a network interface 970 that is coupled to a network. The processor 910 may be a central processing unit (CPU) or a semiconductor device that executes processing instructions stored in the memory 920 and/or the storage 930. The memory 920 and the storage 930 may include various forms of volatile or non-volatile storage media. For example, the memory may include a read-only memory (ROM) 924 and a random access memory (RAM) 925.

Hereinabove, the present invention has been described with reference to exemplary embodiments thereof. Many exemplary embodiments other than the above-mentioned exemplary embodiments fall within the scope of the present invention. It will be understood by those skilled in the art to which the present invention pertains that the present invention may be implemented in a modified form without departing from essential characteristics of the present invention. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. A virtualization service apparatus comprising:
a network monitoring unit receiving a virtualization service request for a content and network delay time information from a terminal;
a content monitoring unit setting a delay limitation depending on a type of the content;
a transmission rate controlling unit setting a transmission rate depending on an available bandwidth of a network;
a content bit rate controlling unit setting a content bit rate depending on the transmission rate, the delay limitation, and the network delay time;
an encoding configuration controlling unit setting a resolution and a frame rate depending on the content bit rate and the type of the content;
a content quality controlling unit encoding the content depending on the resolution and the frame rate; and
a transmitting unit transmitting the encoded content to the terminal.

2. The virtualization service apparatus of claim 1, wherein the encoding configuration controlling unit sets the resolution and the frame rate with reference to a profile including resolutions and frame rates preset depending on each content bit rate and each type of the contents.

3. The virtualization service apparatus of claim 1, wherein the content bit rate controlling unit sets the content bit rate depending on the transmission rate, and
the content bit rate controlling unit decreases the content bit rate in the case in which the network delay time exceeds the delay limitation and increases the content bit rate in the case in which the network delay time is the delay limitation or less.

4. The virtualization service apparatus of claim 3, wherein the network monitoring unit receives receiving buffer state information from the terminal and calculates the available bandwidth, and
the transmission rate controlling unit may adjust the transmission rate depending on the available bandwidth and the receiving buffer status information.

5. A method of providing a virtualization service by a virtualization service apparatus, comprising:
receiving a virtualization service request for a content and network delay time information from a terminal;
setting a delay limitation depending on a type of the content;
setting a transmission rate depending on an available bandwidth of a network;
setting a content bit rate depending on the transmission rate, the delay limitation, and the network delay time;
setting a resolution and a frame rate depending on the content bit rate and the type of the content;
encoding the content depending on the resolution and the frame rate; and
transmitting the encoded content to the terminal.

6. The method of providing a virtualization service of claim 5, wherein the setting of the resolution and the frame rate depending on the content bit rate and the type of the content includes setting the resolution and the frame rate with reference to a profile including resolutions and frame rates preset depending on each content bit rate and each type of the contents.

7. The method of providing a virtualization service of claim 5, wherein the setting of the content bit rate depending on the transmission rate, the delay limitation, and the network delay time includes:
setting the content bit rate depending on the transmission rate;
decreasing the content bit rate in the case in which the network delay time exceeds the delay limitation; and
increasing the content bit rate in the case in which the network delay time is the delay limitation or less.

8. The method of providing a virtualization service of claim 7, further comprising:
receiving receiving buffer state information from the terminal;
calculating the available bandwidth; and
wherein setting a transmission rate depending on an available bandwidth of a network includes setting the transmission rate depending on the available bandwidth and the receiving buffer state information.
